(19) United States
(12) Patent Application Publication
(10) Pub. No.: US 2010/0279043 A1
(43) Pub. Date: Nov. 4, 2010

(54) HOUSING AND METHOD OF MANUFACTURING THE SAME

(75) Inventors: JEN-HONG HSU, Tu-Cheng (TW); HAI-LIN CHEN, Shenzhen City (CN); YU-GUO ZHANG, Shenzhen City (CN); YONG YANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/537,406

(22) Filed: Aug. 7, 2009

(30) Foreign Application Priority Data
May 4, 2009 (CN) 200910302091.3

(51) Int. Cl. B32B 1/02; B05D 3/06

(52) U.S. Cl. 428/35.7; 427/555

(57) ABSTRACT

A housing for an electronic device includes a plastic base, a prime layer, a decorative layer, and a transparent protection layer. The prime layer, the decorative layer, and the transparent protection layer are coated on the plastic base in that order. The decorative layer defines a pattern extending through the decorative layer.

### CROSS REFERENCE STATEMENT

This application is related to a co-pending U.S. patent application, which is application [TBD] with Attorney Docket No. US27129, and entitled “HOUSING AND METHOD OF MANUFACTURING THE SAME”. In the co-pending application, the inventors are Jen-Hong Hsu, Hai-Lin Chen, Jian-Wei Zhan, Yong Yang, Ying-Hao Feng, and Yu-Guo Zhang. The co-pending application has the same assignee as the present application.

### BACKGROUND

1. Technical Field

The present disclosure generally relates to device housings, and particularly to a housing for an electronic device and a method of manufacturing the housing.

2. Description of Related Art

Electronic devices such as notebook computers, MP3 players, personal digital assistants, and mobile phones are in common use. A pleasing appearance and finish, such as a metallic finish, are often important to users.

Accordingly textured patterns or stripes are often formed on the exterior housing of such devices. However, such textured patterns or stripes are often integrally formed with a color coating layer on the exterior housing of the electronic device. If the textured patterns or stripes are the same color and configuration as the color coating layer, the textured patterns or stripes may be difficult to discern, thus the appearance of the electronic device may be less appealing than is desired.

Therefore, what is needed, is a housing that overcomes the limitations

### BRIEF DESCRIPTION OF THE DRAWINGS

The components in the drawing are not necessarily drawn to scale, the emphasis instead being placed upon clearly illustrating the principles of the present disclosure.

FIG. 1 is a cross-section of a portion of an embodiment of a housing.

FIG. 2 is a flowchart of an embodiment of a method of manufacturing the housing in FIG. 1.

### DETAILED DESCRIPTION

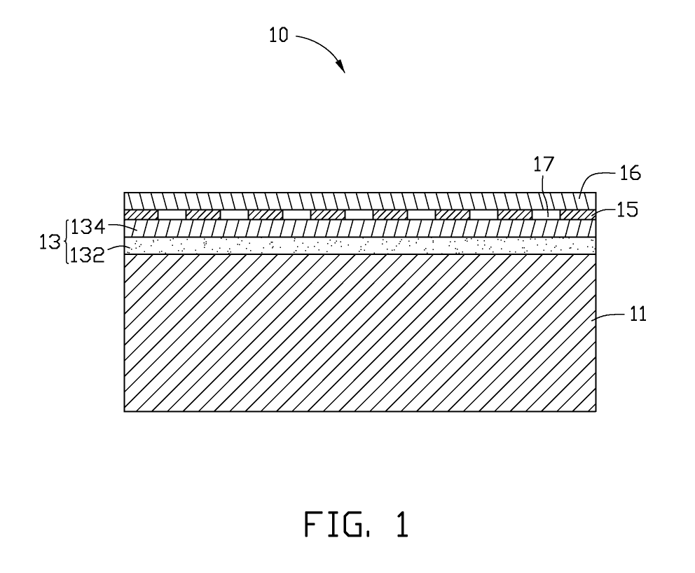

Referring to FIG. 1, an embodiment of a housing 10 includes a plastic base 11, a prime layer 13, a decorative layer 15, and a transparent protection layer 16. The prime layer 13, the decorative layer 15, and the transparent protection layer 16 are coated on the plastic base 11 in that order. The decorative layer 15 defines a pattern 17 extending through the decorative layer 15.

The plastic base 11 may be made of a material selected from the group consisting of acrylonitrile butadiene styrene (ABS), polycarbonate (PC), polyphenylene sulphide (PPS), and any suitable combination thereof.

The prime layer 13 improves a coating performance of the plastic base 11. In the illustrated embodiment, the prime layer 13 includes a connecting layer 132 adjacent to the plastic base 11, and a color coating layer 134 coated on the connecting layer 132.

The connecting layer 132 masks surface defects of the plastic base 11, and enhances bonding between the color coating layer 134 and the plastic base 11. The connecting layer 132 may include acrylic resin, polyester resin, epoxy resin, amino resin, acrylate copolymer, propylene glycol methyl ether acetate (PMA), butyl ester, and pigments dispersed therein. The pigments may be carbon black, exhibiting favorable absorption of laser energy. The thickness of the connecting layer 132 may be about 15 micrometers (μm) to about 20 μm.

The color coating layer 134 normalizes the surface of the plastic base 11 and provides a background color to the pattern 17. The color coating layer 134 may include acrylic resin, polyester resin, epoxy resin, amino resin, acrylate copolymer, PMA, butyl ester, and pigments dispersed therein. The pigments may be any desired color. The thickness of the color coating layer 134 may be about 15 μm to about 80 μm.

The decorative layer 15 may include acrylic resin, polyester resin, epoxy resin, amino resin, acrylate copolymer, PMA, butyl ester, pigments and aluminum oxide powder dispersed therein. The pigments and the aluminum oxide powder may be in a nanometer scale. The aluminum oxide powder is configured to provide metallic luster to the housing 10, and generate a light reflection effect to provide the pattern 17 with a stereoscopic appearance. The thickness of the decorative layer 15 may be about 2 μm to about 7 μm.

The pattern 17 is defined in the decorative layer 15 via laser engraving. In the illustrated embodiment, the pattern 17 extends through the decorative layer 15 to the color coating layer 134. Thus, the pattern 17 shows the color of the color coating layer 134. Alternatively, the pattern 17 may extend through the decorative layer 15 and the color coating layer 134 to the connecting layer 132. Thus, the pattern 17 may show the color of the connecting layer 132.

The transparent protection layer 16 protects the decorative layer 15 and the pattern 17 from abrasion, and improve glossiness of the housing 10. The transparent protection layer 16 may include acrylic resin, polyester resin, epoxy resin, amino resin, silicon dioxide, acrylate copolymer, PMA, and butyl ester. The thickness of the transparent protection layer 16 may be about 20 μm to about 80 μm.

Because the pattern 17 extends through the decorative layer 15 and shows the color of the color coating layer 134, when viewed from the front, the pattern 17 shows a color different from the decorative layer 15, thus the pattern 17 is conspicuously defined in the decorative layer 15. At the same time, the decorative layer 15 provides metallic luster to the housing 10, and generates a light reflection effect to enable the pattern 17 to exhibit a stereoscopic appearance. When viewed from the side, the pattern 17 may show changed color, due to the light reflection of the decorative layer 15 and the light refraction of the transparent protection layer 16.

Alternatively, if the plastic base 11 has minimal surface defects, the connecting layer 132 may be omitted, and the color coating layer 134 can be directly coated on the plastic base 11, or the color coating layer 134 may be omitted, and the decorative layer 15 can be directly coated on the connecting layer 132.

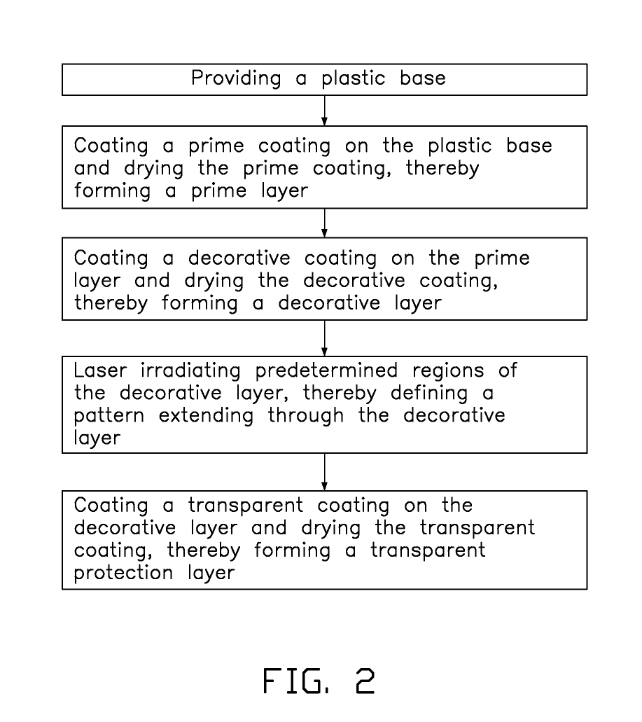

Referring to FIG. 2, an embodiment of a method of manufacturing a housing 10 is also provided.

A plastic base 11 may be manufactured by injection molding.

A prime layer 13 is coated on the plastic base 11. The prime layer 13 includes a connecting layer 132 and a color coating layer 134. A connecting coating is coated on the plastic base 11 and dried, thereby forming the connecting layer 132. A color coating is then coated on the connecting layer 132 and dried, thereby forming the color coating layer 134. The connecting coating may include acrylic resin, polyester resin, epoxy resin, amino resin, acrylate copolymer, PMA, butyl ester, and pigments dispersed therein. The connecting coating may be coated on the plastic base 11 by spray coating. A drying temperature of the connecting coating is about 50 degrees Celsius (° C.) to about 10° C. A drying time of the connecting coating is about 10 minutes to about 30 minutes. The color coating may include acrylic resin, polyester resin, epoxy resin, amino resin, acrylate copolymer, PMA, butyl ester, and pigments dispersed therein. The color coating may be coated on the connecting layer 132 by spray coating. A drying temperature of the color coating is about 50° C. to about 100° C. A drying time of the color coating is about 10 minutes to about 30 minutes.

A decorative coating is coated on the color coating layer 134 and dried, thereby forming a decorative layer 15. The decorative coating may include acrylic resin, polyester resin, epoxy resin, amino resin, acrylate copolymer, PMA, butyl ester, pigments and aluminum oxide powder dispersed therein. The decorative coating may be coated on the color coating layer 134 by spray coating. A drying temperature of the decorative coating is about 50° C. to about 100° C. A drying time of the decorative coating is about 10 minutes to about 30 minutes.

The plastic base 11 is received in a laser engraver, and predetermined regions of the decorative layer 15 are engraved. The materials of the decorative layer 15 at the predetermined regions disintegrate due to the energy of the laser, thus defining a pattern 17 in the decorative layer 15. The power of the laser is adjusted to enable the pattern 17 to extend through the decorative layer 15.

A transparent coating is coated on the decorative layer 15 and dried, thereby forming a transparent protection layer 16. The transparent coating may include acrylic resin, polyester resin, epoxy resin, amino resin, silicon dioxide, acrylate copolymer, PMA, and butyl ester. The transparent coating may be coated on the decorative layer 15 by spray coating. A drying temperature of the transparent coating is about 50° C. to about 100° C. A drying time of the transparent coating is about 10 minutes to about 30 minutes.

Alternatively, the connecting layer 132 may be omitted, and the color coating layer 134 directly coated on the plastic base 11, or the color coating layer 134 may be omitted, and the decorative layer 15 directly coated on the connecting layer 132.

In one embodiment of a method of manufacturing a housing 10, a plastic base 11 is injection molded of ABS. A connecting coating is coated on the plastic base 11 and dried for about 30 minutes, at about 50° C., thus forming a connecting layer 132 about 20 μm thick. A decorative coating is coated on the connecting layer 132 and dried for about 10 minutes, at about 100° C., thus forming a decorative layer 15 about 2 μm thick. A laser is irradiated on the predetermined regions of the decorative layer 15, thus defining a pattern 17 extending through the decorative layer 15. Finally, a transparent coating is coated on the decorative layer 15 and dried for about 10 minutes, at about 100° C., thus forming a transparent protection layer 16 about 50 μm thick.

In another embodiment of a method of manufacturing a housing 10, a plastic base 11 is injection molded of PC. A color coating is coated on the plastic base 11 and dried for about 10 minutes, at about 100° C., thus forming a color coating layer 134 about 25 μm thick. A decorative coating is coated on the color coating layer 134 and dried for about 15 minutes, at about 80° C., thus forming a decorative layer 15 about 5 μm thick. A laser is irradiated on the predetermined regions of the decorative layer 15, thus defining a pattern 17 extending through the decorative layer 15. Finally, a transparent coating is coated on the decorative layer 15 and dried for about 30 minutes, at about 50° C., thus forming a transparent protection layer 16 about 80 μm thick.

In yet another embodiment of a method of manufacturing a housing 10, a plastic base 11 is injection molded of ABS and PC. A connecting coating is coated on the plastic base 11 and dried for about 10 minutes, at about 100° C., thus forming a connecting layer 132 about 15 μm thick. A color coating is coated on the connecting layer 132 and dried for about 30 minutes, at about 50° C., thus forming a color coating layer 134 about 50 μm thick. A decorative coating is coated on the color coating layer 134 and dried for about 30 minutes, at about 50° C., thus forming a decorative layer 15 about 7 μm thick. A laser is irradiated on the predetermined regions of the decorative layer 15, thus defining a pattern 17 extending through the decorative layer 15. Finally, a transparent coating is coated on the decorative layer 15 and dried for about 15 minutes, at about 80° C., thus forming a transparent protection layer 16 about 20 μm thick.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A housing for an electronic device, comprising:
a plastic base; and
a prime layer, a decorative layer, and a transparent protection layer coated on the plastic base in that order;
wherein the decorative layer defines a pattern extending through the decorative layer.

2. The housing of claim 1, wherein the prime layer comprises a connecting layer adjacent to the plastic base, and a color coating layer coated on the connecting layer.

3. The housing of claim 2, wherein the pattern extends through the decorative layer to the color coating layer to show the color thereof.

4. The housing of claim 2, wherein the pattern extends through the decorative layer and the color coating layer to the connecting layer to show the color thereof.

5. The housing of claim 2, wherein the connecting layer comprises a material selected from the group consisting of acrylic resin, polyester resin, epoxy resin, amino resin, acrylate copolymer, propylene glycol methyl ether acetate, butyl ester, and any suitable combination thereof; the connecting layer also comprises pigments dispersed therein.

6. The housing of claim 2, wherein the color coating layer comprises a material selected from the group consisting of acrylic resin, polyester resin, epoxy resin, amino resin, acrylate copolymer, propylene glycol methyl ether acetate, butyl ester, and any suitable combination thereof; the color coating layer also comprises pigments dispersed therein.

7. The housing of claim 1, wherein the decorative layer comprises a material selected from the group consisting of acrylic resin, polyester resin, epoxy resin, amino resin, acrylate copolymer, propylene glycol methyl ether acetate, butyl ester, and any suitable combination thereof; the decorative layer also comprises pigments and aluminum oxide powder dispersed therein.

8. The housing of claim 7, wherein the pigments and the aluminum oxide powder are in a nanometer scale.

9. The housing of claim 1, wherein the transparent protection layer comprises a material selected from the group consisting of acrylic resin, polyester resin, epoxy resin, amino resin, acrylate copolymer, propylene glycol methyl ether acetate, butyl ester, and any suitable combination thereof; the transparent protection layer also comprises silicon dioxide dispersed therein.

10. The housing of claim 1, wherein the pattern is defined in the decorative layer via laser engraving.

11. The housing of claim 2, wherein the thickness of the connecting layer is about 15 μm to about 20 μm, the thickness of the color coating layer is about 15 μm to about 80 μm, the thickness of the decorative layer is about 2 μm to about 7 μm, and the thickness of the transparent protection layer is about 20 μm to about 80 μm.

12. A housing for an electronic device, comprising:
a plastic base;
a color coating layer coated on the plastic base;
a decorative layer coated on the color coating layer, the decorative layer comprising aluminum oxide powder, a color of the decorative layer being different from that of the color coating layer; and
a pattern defined in the decorative layer, the pattern extending through the decorative layer to show the color of the color coating layer.

13. The housing of claim 12, further comprising a connecting layer coated on the plastic base, wherein the color coating layer is coated on the connecting layer.

14. The housing of claim 12, further comprising a transparent protection layer coated on the decorative layer.

15. The housing of claim 12, wherein the pattern is defined in the decorative layer via laser engraving.

16. A method of manufacturing a housing for an electronic device, comprising:
providing a plastic base;
coating a prime coating on the plastic base and drying the prime coating, thereby forming a prime layer;
coating a decorative coating on the prime layer and drying the decorative coating, thereby forming a decorative layer;
laser irradiating predetermined regions of the decorative layer, thereby defining a pattern extending through the decorative layer; and
coating a transparent coating on the decorative layer and drying the transparent coating, thereby forming a transparent protection layer.

17. The method of manufacturing a housing of claim 16, wherein the prime layer comprises a connecting layer adjacent to the plastic base, and a color coating layer coated on the connecting layer; a connecting coating is coated on the plastic base and dried, thereby forming the connecting layer; and a color coating is then coated on the connecting layer and dried, thereby forming the color coating layer.

18. The method of manufacturing a housing of claim 17, wherein a drying temperature of the connecting coating is about 50° C. to about 100° C., a drying time of the connecting coating is about 10 minutes to about 30 minutes; a drying temperature of the color coating is about 50° C. to about 100° C., a drying time of the color coating is about 10 minutes to about 30 minutes.

19. The method of manufacturing a housing of claim 16, wherein a drying temperature of the decorative coating is about 50° C. to about 100° C., a drying time of the decorative coating is about 10 minutes to about 30 minutes.

20. The method of manufacturing a housing of claim 16, wherein a drying temperature of the transparent coating is about 50° C. to about 100° C., a drying time of the transparent coating is about 10 minutes to about 30 minutes.
